(19) United States
(12) Patent Application Publication
(10) Pub. No.: US 2010/0047037 A1
(43) Pub. Date: Feb. 25, 2010

(54) NUT

(75) Inventors: Rikiya Ishida, Gifu (JP); Manabu Naoi, Gifu (JP)

Correspondence Address: BUCHANAN, INGERSOLL & ROONEY PC, POST OFFICE BOX 1404, ALEXANDRIA, VA, 22313-1404, US

(73) Assignee: MEIRA Corporation, Nagaya-shi, Aichi (JP)

(21) Appl. No.: 12/516,552

(22) PCT Filed: Nov. 27, 2007
(86) PCT No.: PCT/JP2007/072834

§ 371 Date: Jun. 30, 2009

(30) Foreign Application Priority Data
Nov. 29, 2006 (JP) 2006-322449

(51) Int. Cl. F16B 37/00

(52) U.S. Cl. 411/427

(57) ABSTRACT

A nut 1 of the present invention has a nut body 2 including a female screw part 5 extended axially and a flange part 4 projected outward from a side surface of the nut body 2; and an unconductive ring-shaped resinous member 3 covering a peripheral portion of the flange part 4. The flange part 4 has a disk-shaped flange body portion 41; and a seat surface-forming portion 42 which is extended downward from a lower surface of the flange body portion 41, has a smaller diameter than the flange body portion 41, and has a seat surface 43 to be pressed against a portion where the nut is to be mounted. The unconductive ring-shaped resinous member 3 has an edge part 31 located below the seat surface 43 and outward from the flange body portion 4; and an annular skirt part 32 whose diameter gradually increases to the edge part 31. The annular skirt part 32 deforms in mounting the nut on the portion where the nut is to be mounted and forms an annular liquid-tight sealing portion for the portion where the nut is to be mounted.

### TECHNICAL FIELD

The present invention relates to a nut tightened to a portion required to have a sealing performance or effectively mounted on a molded product made of a metal such as magnesium, a magnesium alloy or the like which is liable to generate electrolytic corrosion.

### BACKGROUND ART

As various members (for example, oil pan, engine head cover, AT mission case) of a car and the like, recently, molded products made of magnesium or a magnesium alloy are used. When a nut made of a metal such as iron having a higher electric potential than the above-described members is used to bind the members tightly, an electrolytic corrosion action may occur at a portion where different kinds of metals contact each other and thus the members may corrode. Thus, a method of preventing the occurrence of the electrolytic corrosion by interposing an insulation washer between different kinds of metals to be fixedly bound to each other with a nut and a method of treating the surface of the nut or the like to prevent the occurrence of the electrolytic corrosion are conceivable. In these methods, there is a possibility that the washer and the nut rub each other, which may result in a decrease of an electrolytic corrosion effect or there is a possibility that an electrolytic corrosion prevention film separates from the surface of the nut or the like, which may result in a decrease of the electrolytic corrosion effect.

The nut is also proposed as disclosed in Japanese Utility Model Registration No. 3042599.

The nut is a fastening member to be engaged by the male screw of the bolt inserted into through-holes formed through not less than two members where the nut is to be mounted. The members where the nut is to be mounted are fixedly fastened by means of the bolt and the nut in the nut disclosed in Japanese Utility Model Registration No. 3042599, the sliding member composed of the covering member consisting of the synthetic resin film is interposed between the seat surface of the bolt and that of the nut.

### DISCLOSURE OF THE INVENTION

### Problem to be Solved by the Invention

In the nut disclosed in Japanese Utility Model Registration No. 3042599, in mounting the nut on the portion where the nut is to be mounted, the film is interposed between the nut and the portion where the nut is to be mounted. Thus the axial force is held by the contact surface of the film and that of the portion where the nut is to be mounted. Therefore it is impossible to transmit a sufficient axial force. The nut disclosed in Japanese Utility Model Registration No. 3042599 has the boundary between the nut and the film and the boundary between the film and the portion where the nut is to be mounted. Therefore after the nut is mounted on the portion where the nut is to be mounted, the liquid-tight sealing property cannot be held sufficiently.

An object of the present invention is to provide a nut which is capable of holding an axial force by a seat surface thereof when the nut is mounted on a metal molded product liable to generate electrolytic corrosion and securely preventing a liquid from penetrating into a portion of the metal molded product where the nut is to be mounted and the metal molded product from generating the electrolytic corrosion.

### Means for Solving the Problem

To achieve the above-described object in a nut of the present invention having a nut body including a female screw part extended axially and a flange part projected outward from a side surface of the nut body and an unconductive ring-shaped resinous member covering a peripheral portion of the flange part, the flange part has a disk-shaped flange body portion and a seat surface-forming portion which is extended downward from a lower surface of the flange body portion and has a smaller diameter than the flange body portion and a seat surface to be pressed against a portion where the nut is to be mounted; the unconductive ring-shaped resinous member has an edge part located below the seat surface and outward from the flange body portion and an annular skirt part whose diameter gradually increases to the edge part; and the annular skirt part deforms in mounting the nut on the portion where the nut is to be mounted in such a way that the annular skirt part does not prevent the seat surface from being pressed against the portion where the nut is to be mounted and forms an annular liquid-tight sealing portion for the portion where the nut is to be mounted.

### BRIEF DESCRIPTION OF THE DRAWINGS

FIG. 1 is a front view of a nut of an embodiment of the present invention.

FIG. 2 is a plan view of the nut shown in FIG. 1.

FIG. 3 is a sectional view taken along a line A-A of FIG. 1.

FIG. 4 is an explanatory view for explaining the nut of the embodiment of the present invention.

FIG. 5 is an explanatory view for explaining a nut of another embodiment of the present invention.

FIG. 6 is an explanatory view for explaining a nut of still another embodiment of the present invention.

FIG. 7 is an explanatory view for explaining a nut of still another embodiment of the present invention.

FIG. 8 is an explanatory view for explaining a nut of still another embodiment of the present invention.

FIG. 9 is an explanatory view for explaining a nut of still another embodiment of the present invention.

FIG. 10 is an explanatory view for explaining a nut of still another embodiment of the present invention.

FIG. 11 is an explanatory view for explaining the action of the nut of the present invention.

FIG. 12 is a front view of a nut of another embodiment of the present invention.

FIG. 13 is a sectional view taken along a line B-B of FIG. 12.

FIG. 14 is a front view of a nut of still another embodiment of the present invention.

FIG. 15 is a sectional view taken along a line C-C of FIG. 14.

### BEST MODE FOR CARRYING OUT THE INVENTION

The nut of the present invention is described below by using embodiments shown in the drawings.

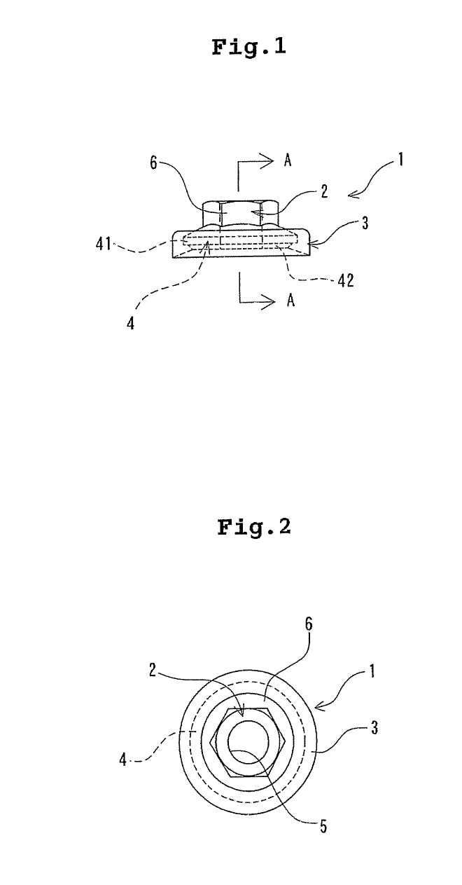

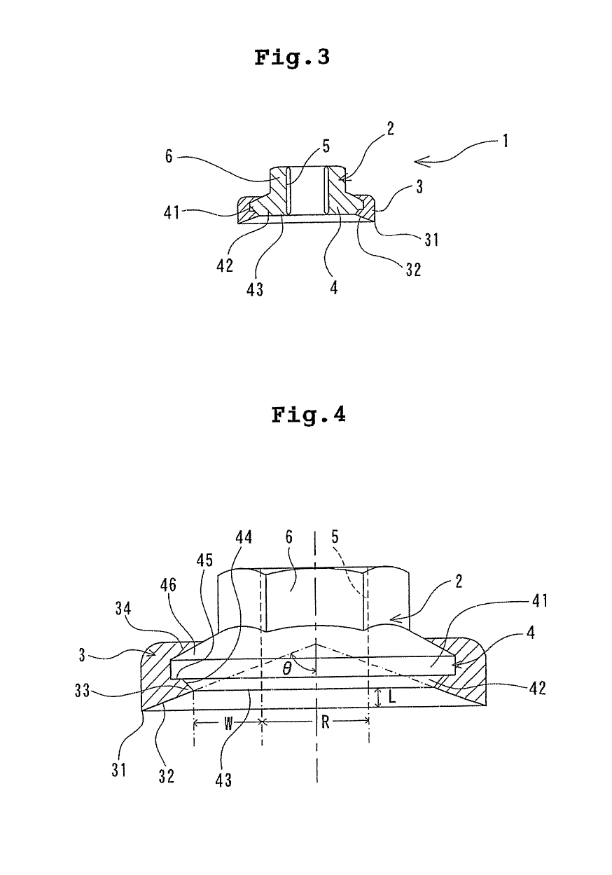

FIG. 1 is a front view of a nut of an embodiment of the present invention. FIG. 2 is a plan view of the nut shown in FIG. 1. FIG. 3 is a sectional view taken along a line A-A of FIG. 1. FIG. 4 is an explanatory view for explaining the nut of the embodiment of the present invention.

A nut 1 of the present invention has a nut body 2 including a female screw part 5 extended axially and a flange part 4 projected outward from a side surface of the nut body 2; and an unconductive ring-shaped resinous member 3 covering a peripheral portion of the flange part 4.

The flange part 4 has a disk-shaped flange body portion 41; and a seat surface-forming portion 42 which is extended downward from a lower surface of the flange body portion 41, has a smaller diameter than the flange body portion 41, and has a seat surface 43 to be pressed against a portion where the nut is to be mounted.

The unconductive ring-shaped resinous member 3 has an edge part 31 located below the seat surface 43 and outward from the flange body portion 4; and an annular skirt part 32 whose diameter gradually increases to the edge part 31. The annular skirt part 32 deforms in mounting the nut on the portion where the nut is to be mounted in such a way that the annular skirt part 32 does not prevent the seat surface 43 from being pressed against the portion where the nut is to be mounted and forms an annular liquid-tight sealing portion for the portion where the nut is to be mounted. The nut of the present invention is especially effective for preventing the occurrence of electrolytic corrosion.

As shown in FIG. 1 through FIG. 4, the nut l of the present invention has the nut body 2 and the unconductive ring-shaped resinous member 3 covering the peripheral portion of the flange part 4 of the nut body 2.

The nut body 2 is made of an iron-based steel material such as high tensile strength steel and stainless steel. As shown in FIG. 1 through FIG. 4, the nut body 2 has a head part 6, the flange part 4 provided at a lower end of the head part, and the female screw part 5 provided inside the nut body 2. The female screw part 5 is formed on an inner surface of a concave portion or a through passage extended axially upward from a lower end of the nut body 2. In the nut 1 of this embodiment, the nut body 2 has the through passage extended from a lower-end surface thereof to an upper end thereof. The female screw part 5 is formed on the entire inner surface of the through passage. Therefore the nut body 2 is formed as a ring-shaped member having a predetermined length in the axial direction thereof. In this embodiment the head part 6 is formed in the shape of a polygonal pillar so that an operation of rotating the head part 6 is performed with a wrench or the like.

The nut 1 has the flange part 4 which is formed at the lower end of the head part 6 and has a larger outer diameter than the head part 6. As shown in FIG. 1 through FIG. 4, the flange part 4 has the disk-shaped flange body portion 41 and the seat surface-forming portion 42 which is extended downward from the lower surface of the flange body portion 41 and has a smaller diameter than the flange body portion 41 and the seat surface 43 to be pressed against the portion where the nut is to be mounted. The seat surface 43 is formed as an annular flat portion and capable of holding a predetermined axial force when the nut is mounted on the portion where the nut is to be mounted.

In the nut 1 of this embodiment, the seat surface-forming portion 42 has a smaller diameter than the flange body portion 41, and an annular side surface 44 of the seat surface-forming portion 42 forms a tapered portion whose diameter decreases to the seat surface 43. On the lower surface of the flange body portion 41, an annular flat portion 45 is formed between an upper-end peripheral edge of the annular side surface 44 and a peripheral edge of the lower surface of the flange body portion 41. The flange body portion 41 has the shape of a disk having substantially equal outer diameters. A tapered portion 46 whose diameter decreases to the head part 6 is formed on an upper surface of the flange body portion 41.

The seat surface 43 is formed as a ring-shaped flat surface. A preferable width W (FIG. 4) of the seat surface 43 is different according to the thickness of the nut (in other words, the inner diameter of the female screw part). The width W of the seat surface 43 with respect to the inner diameter R of the female screw part of the nut is favorably 0.2 Rmm to 1.6 Rmm and especially favorably 0.4 Rmm to 1.2 Rmm. A preferable area of the seat surface is also different according to the size of the nut (in other words, the inner diameter of the female screw part). The area of the seat surface with respect to the inner diameter R of the female screw part of the nut is favorably 3 Rmm² to 160 Rmm² and especially favorably 8 Rmm² to 100 Rmm². The annular flat portion 45 formed on the lower surface of the flange body portion 41 is also formed as a ring-shaped flat surface. A width of the annular flat portion 45 is favorably 0.2 mm to 1.5 mm and especially favorably 0.5 mm to 1.0 mm. A preferable outer diameter of the flange body portion 41 is different according to the size of the nut (in other words, the inner diameter of the female screw part). The outer diameter of the flange body portion 41 with respect to the inner outer diameter R of the female screw part of the nut is favorably 1.3 Rmm to 4.3 Rmm and especially favorably 1.7 Rmm to 3.5 Rmm.

As shown in FIGS. 1 through 4, the unconductive ring-shaped resinous member 3 covers the peripheral portion of the flange part 4 of the nut body 2 and is unseparably fixed to the flange part 4 of the nut body 2. As a material forming the ring-shaped resinous member 3, a material which is unconductive and has a certain degree of hardness and elastic deformability is used. It is desirable that the unconductive ring-shaped resinous member 3 is formed on the nut body 2 by insert molding. Therefore as the material forming the ring-shaped resinous member 3, thermoplastic resins which can be insert-molded are used. The insert molding herein means that after the formed nut body is inserted into a die, the ring-shaped resinous member is formed by injection of a melted resin.

The tensile break elongation of the material forming the ring-shaped resinous member is favorably not less than 10%, more favorably not less than 15%, and most favorably not less than 20%.

As examples of materials forming the ring-shaped resinous member 3, it is possible to use polyacetal; polycarbonate; polyester (polyethylene terephthalate, polybutylene terephthalate); polyolefin polyethylene, polypropylene, ethylene-propylene copolymer); polyamide (nylon 6, nylon 66); polysulfone; polyarylate; blend polymers or polymer alloys of these substances. The polyacetal and the polyamide are especially preferable.

As examples of materials forming the ring-shaped resinous member 3, synthetic rubber such as urethane rubber, silicone rubber, butadiene rubber, propylene rubber; natural rubber such as latex rubber; and elastomers such as olefin elastomers (polyethylene elastomer, polypropylene elastomer); amide elastomers (polyamide elastomer); styrene elastomers (for example, styrene-butadiene-styrene copolymer, styrene-isoprenestyrene copolymer, styrene-ethylene butylene-styrene copolymer); urethane elastomers (polyurethane elastomer of polyester family, polyurethane elastomer of polyether family) may be used.

In the nut 1 of this embodiment the ring-shaped resinous member 3 does not cover the seat surface 43 of the seat surface-forming portion 42, but covers the annular side surface (tapered portion) 44 of the seat surface-forming portion 42, the annular side surface of the flange body portion 41, and an annular peripheral edge of the upper-surface tapered portion 46 of the flange body portion 41. In the nut 1 of this embodiment, as described above, the outer diameter (maximum outer diameter) of the seat surface-forming portion 42 is set smaller than the outer diameter of the flange body portion 41. Therefore a lower annular portion 33 of the ring-shaped resinous member 3 which contacts the annular side surface 44 of the seat surface-forming portion 42 is located below the flange body portion 41. Therefore the ring-shaped resinous member 3 does not cover the seat surface 43 of the seat surface-forming portion 42, but covers the annular side surface 44 of the seat surface-forming portion 42, the annular flat portion 45 of the flange body portion 41, the annular side surface of the flange body portion 41, and the annular peripheral edge of the upper surface of the flange body portion 41.

Therefore the flange body portion 41 is sandwiched between the lower annular portion 33 and an upper annular portion 34 covering the annular peripheral edge of the upper surface 46 of the flange body portion 41. Thereby the ring-shaped member 3 is prevented from being separated from the nut body 2 in performing an operation of mounting the nut on the portion where the nut is to be mounted and after the nut-mounting operation is performed. The lower annular portion 33 has a form of contacting the tapered portion 44 of the seat surface-forming portion 42. More specifically, the lower annular portion 33 has the shape of a wedge extended to the peripheral edge of the seat surface 43.

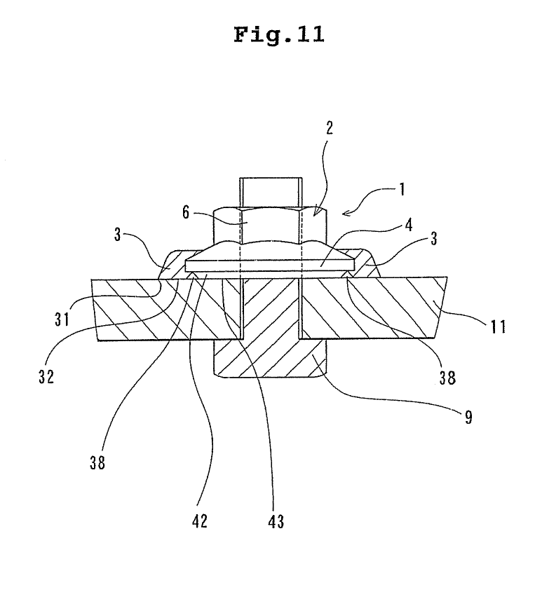

Because the annular skirt part 32 deforms when the nut is mounted on the portion where the nut is to be mounted, a contact surface of the lower annular portion 33 in contact with the annular flat portion 45 of the flange body portion 41 is stretched outward. Thus there is a possibility that the area of the contact surface decreases. As shown in FIG. 11, in mounting the nut on the portion 11 where the nut is to be mounted, the annular flat portion 45 is sandwiched under pressure between the portion 11 where the nut is to be mounted and the flange part 4. Thus in mounting the nut of the present invention on the portion where the nut is to be mounted, a liquid-tight state between the lower annular portion 33 of the annular skirt part 32 and the annular flat portion 45 of the flange body portion 41 is securely formed.

In this embodiment, the ring-shaped resinous member 3 has the edge part 31 which is located below the seat surface 43 and outward (in other words, outward from the peripheral edge of the flange body portion 41) from the flange body portion 41 and the annular skirt part 32 whose diameter increases to the edge part 31. The unconductive ring-shaped resinous member 3 becomes gradually thinner to the edge part 31. Thereby in mounting the nut on the portion where the nut is to be mounted, the edge part is easily deformable. The annular skirt part 32 of the ring-shaped resinous member 3 deforms in mounting the nut on the portion where the nut is to be mounted in such a way that the annular skirt part does not prevent the seat surface 43 from being pressed against the portion where the nut is to be mounted and forms an annular liquid-tight sealing portion for the portion where the nut is to be mounted. It is preferable that the diameter of the annular skirt part 32 becomes gradually larger to the edge part 31. In this embodiment the annular skirt part 32 becomes taperingly larger to the edge part 31 in the diameter thereof.

A taper angle θ (FIG. 4) of the annular skirt part with respect to the axis of the female screw part is favorably 60° to 89° and especially favorably to 65° to 86°. A projected length L (FIG. 4) of a distal end of the edge part 31 with respect to the seat surface 43 is favorably 0.05 mm to 1.5 mm and especially favorably 0.1 mm to 0.7 mm.

In the nut 1 of this embodiment as shown in FIGS. 1 through 4, an inner edge of the annular skirt part 32 is coincident with an outer edge of the seat surface 43. Thus the annular skirt part 32 has a form that it is extended from the outer edge of the seat surface 43 to the edge part 31. The distal end of the edge part 31 forms the peripheral edge of the ring-shaped resinous member 3.

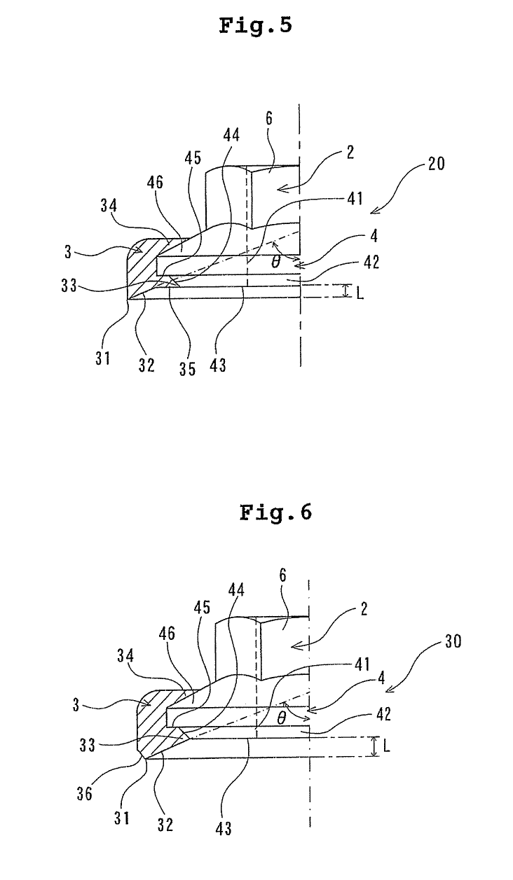

The form of the ring-shaped resinous member 3 is not limited to the above-described one. For example, as with a nut 20 shown in FIG. 5, as the form of the ring-shaped resinous member 3, the inner edge of the annular skirt part 32 may be positioned outward from the outer edge of the seat surface 43. In the nut 20 of this embodiment the lower annular portion 33 of the ring-shaped resinous member 3 has an annular flat surface 35 which does not project below the seat surface 43.

As with a nut 30 shown in FIG. 6, as the form of the ring-shaped resinous member 3, the distal end of the edge part 31 forming the outer edge of the annular skirt part 32 may be positioned inward from the peripheral surface of the ring-shaped resinous member 3. The nut 30 of this embodiment has an annular outer tapered surface 36 extended to the edge part 31. Therefore the inner side of the edge part 31 is constructed of the annular skirt part 32, whereas the outer side thereof is constructed of the annular outer tapered surface 36. Thus the edge part 31 forms a projected portion extended toward the lower end of the nut.

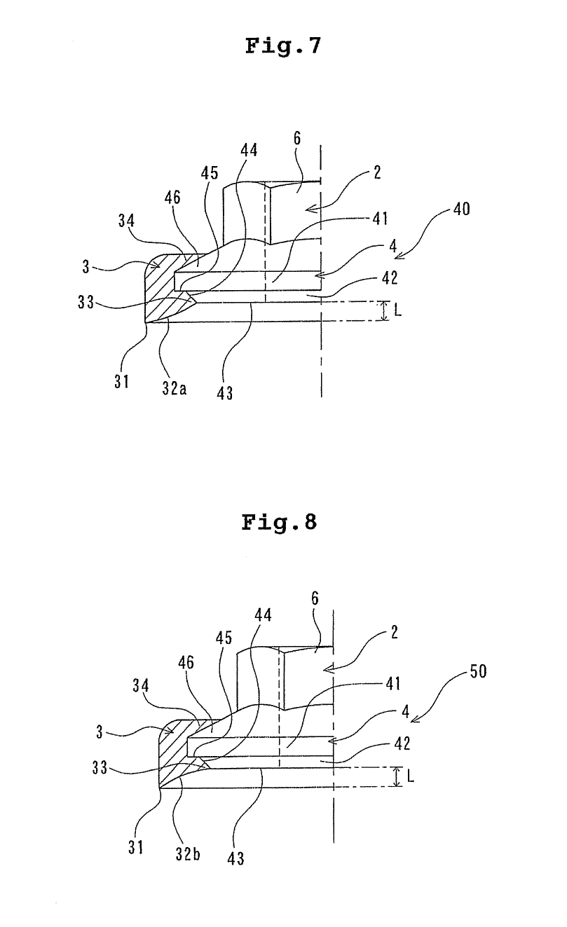

The form of the annular skirt part is not limited to the above-described tapered one, but as with a nut 40 shown in FIG. 7, an annular skirt part 32a may be curvedly extended to the distal end of the edge part 31. In this example, the annular skirt part 32a has a curved surface which bulges outward. Further as with a nut 50 shown in FIG. 8, an annular skirt part 32b may have a curved surface which is concave to the inside of the ring-shaped resinous member 3.

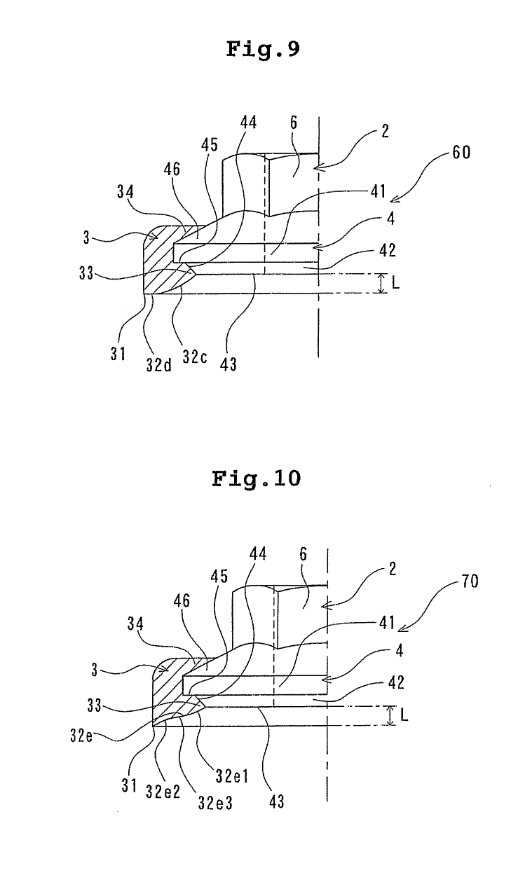

As with a nut 60 shown in FIG. 9, an annular skirt part 32c may have a flat portion (almost parallel with seat surface) 32d formed in the vicinity of the edge part 31. As the nut 60 shown in FIG. 9, the annular skirt part 32c has a curved portion bulged outward and the flat portion 32d extended from an end of the curved portion to the edge part.

As with a nut 70 shown in FIG. 10, an annular skirt part 32e may have an inner annular portion 32e1 having a curved surface bulged outward and an outer annular portion 32e2 inwardly curved a little. In this configuration, when the nut is tightened, owing to deformation of the inner annular portion 32e1 bulged outward, it is possible to securely seal the gap between the lower annular portion 33 of the ring-shaped resinous member 3 and the annular flat portion 45 of the flange body portion 41 of the nut body 2. Further owing to deformation of the outer annular portion 32e2 inwardly curved a little, it is possible to securely seal the gap between the peripheral edge of the ring-shaped resinous member 3 and a metal molded product which is an object where the nut is to be fixed. Further as with the nut 70 shown in FIG. 10, the nut 70 may have a flat portion (almost parallel with seat surface) 32e3 disposed at a boundary between the inner annular portion 32e1 having the curved surface bulged outward and the outer annular portion 32e2 inwardly curved a little.

In the ring-shaped resinous member 3 of the nut of the present invention, the annular skirt part 32 elastically deforms when the nut is mounted on the portion where the nut is to be mounted. Following the deformation of the annular skirt part 32, the ring-shaped resinous member 3 is pressed against the annular peripheral edge of the upper surface of the flange body portion. More specifically, as shown in FIG. 11, when the nut 1 of the present invention is mounted on the portion where the nut 1 is to be mounted, the annular skirt part 32 of the ring-shaped resinous member 3 deforms outward. Following the deformation (affected by the deformation), the upper annular portion 34 of the ring-shaped member 3 deforms inward. Thereby the ring-shaped member 3 is pressed against the annular peripheral portion of the upper surface 46 of the flange body portion 41. Thus the liquid-tight property therebetween is improved. The above-described elastic deformation means deformation which displays a certain extent of a restoring force to the original configuration and does not mean a complete restoration to the configuration before the nut is mounted on the portion where the nut is to be mounted, when the nut is removed therefrom.

As shown in FIG. 11, the ring-shaped resinous member 3 may be so constructed that it deforms in mounting the nut on the portion 11 where the nut is to be mounted and the annular skirt part 32 thereof separates from the side surface of the seat surface-forming portion 42 (in other words, the lower annular portion 33 separates from the tapered portion 44). In this case, as shown in FIG. 11, the deformed ring-shaped resinous member 3 forms an annular space 38 between the side surface of the seat surface-forming portion 42 and the annular skirt part 32. By allowing the above-described separation to be accomplished, the annular skirt part 32 of the ring-shaped resinous member 3 is deformable more easily.

In the nut of the present invention, when the nut is mounted on the portion where the nut is to be mounted, the nut is capable of displaying a predetermined axial force with the seat surface thereof being pressed against the surface of the portion where the nut is to be mounted, and the annular skirt part of the unconductive ring shaped resinous member closely contacts the surface of the portion where the nut is to be mounted, thereby preventing the penetration of water into the gap between the nut and the portion where the nut is to be mounted and preventing the electrolytic corrosion from being generated by the flow of electric current between the nut and the portion where the nut is to be mounted.

As shown in FIG. 11, the nut 1 of the present invention is mounted on the portion (for example, component parts of car) of a molded product made of a metal such as magnesium or a magnesium alloy, which is liable to generate a potential difference between the molded product and the material forming the nut body.

In the example shown in FIG. 11, the portion where the nut is to be mounted is constructed of a plate 11 made of the magnesium or the magnesium alloy and a bolt 9.

The nut 1 of the present invention is engaged by a male screw part of the bolt 9 penetrating a hole formed through the plate 11. As the engagement therebetween progresses, the edge part 31 of the annular skirt part 32 of the ring-shaped resinous member 3 contacts the plate 11. By further progressing the engagement therebetween, the annular skirt part 32 contacts the plate 11 and deforms outward. A nut-mounting work finishes when the seat surface 43 of the nut 1 is pressed against the surface of the plate 11 to obtain a state shown in FIG. 11.

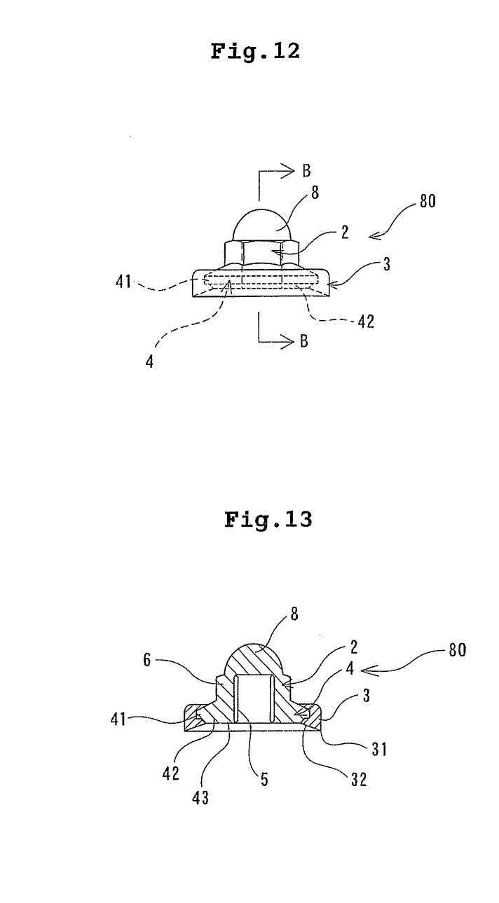

The form of the nut is not limited to the above-described forms. The nuts of all the above-described embodiments may have a form as shown in FIG. 12 and FIG. 13 which is a sectional view taken along a line B-B of FIG. 12. A nut 80 of an embodiment shown in FIGS. 12 and 13 is a bag-shaped nut in which an upper portion of the female screw part 5 is closed. More specifically, the nut body 2 has a closed part 8 projected upward from an upper end of the head part 6. The closed part 8 is dome-shaped in its outer configuration.

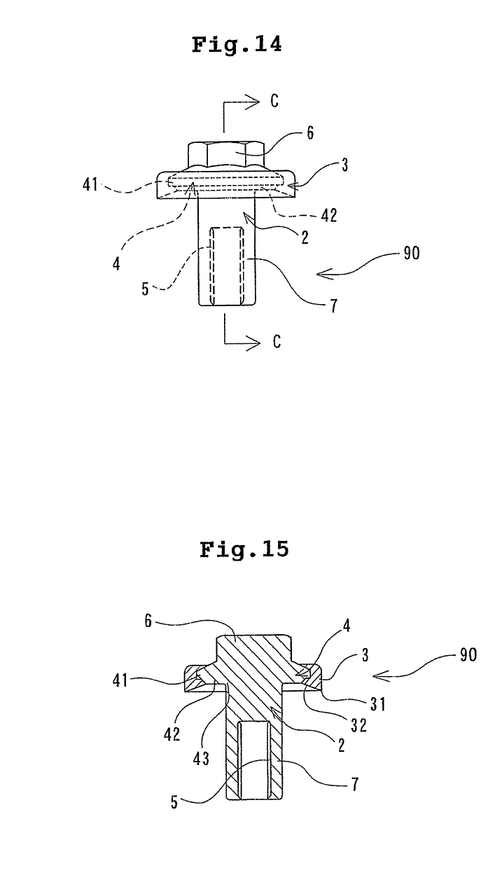

The nuts of all the above-described embodiments may have a form as shown in FIG. 14 and FIG. 15 which is a sectional view taken along a line C-C of FIG. 14. In a nut 90 of an embodiment shown in FIGS. 14 and 15, the nut body 2 has a shaft part 7 extended downward from the flange part 4. The shaft part 7 is provided with the female screw part 5. The length of the shaft part 7 is determined appropriately according to a use. It is preferable that an inner diameter Y of the female screw part is X/4 to 3X/4 with respect to an outer diameter X of the shaft part 7. The length of the female screw part may be set less than the whole length of the shaft part 7 or the female screw part may reach the head part 6. The nut shown in FIGS. 14 and 15 is bag-shaped and the female screw part 5 does not penetrate therethrough. But the female screw part may penetrate the nut body.

The forms of the nuts of all the above-described embodiments may be so-called locking nuts.

The present invention is not limited to the above-described embodiments, but various modifications can be made without departing from the gist of the present invention. Although the above-described embodiments have been described by exemplifying the case in which the nut is used to combine the plate with the member where the nut is to be fixed, the present invention is not limited to the example. The nut of the present invention can be utilized for various parts in addition to the parts of a car.

### INDUSTRIAL APPLICABILITY

The nut of the present invention has the following forms:

(1) In the nut of the present invention having the nut body including the female screw part extended axially and the flange part projected outward from the side surface of the nut body and the unconductive ring-shaped resinous member covering the peripheral portion of the flange part, the flange part has the disk-shaped flange body portion and the seat surface-forming portion which is extended downward from the lower surface of the flange body portion and has a smaller diameter than the flange body portion and the seat surface to be pressed against the portion where the nut is to be mounted; the ring-shaped resinous member has the edge part located below the seat surface and outward from the flange body portion and the annular skirt part whose diameter gradually increases to the edge part; and the annular skirt part deforms in mounting the nut on the portion where the nut is to be mounted in such a way that the annular skirt part does not prevent the seat surface from being pressed against the portion where the nut is to be mounted and forms the annular liquid-tight sealing portion for the portion where the nut is to be mounted.

Therefore the nut is capable of holding the axial force thereof exerted by the seat surface thereof when the nut is mounted on the metal molded product liable to cause the electrolytic corrosion and securely preventing a liquid from penetrating into the portion of the metal molded product where the nut is to be mounted and the metal molded product from causing the electrolytic corrosion.

The embodiments of the nut may have the following forms.

(2) In the nut according to the above-described (1), the annular skirt part increases to the edge part in the diameter thereof taperingly or cursedly.

(3) In the nut according to the above-described (1) or (2), the nut body has the annular side surface formed by the side surface of the seat surface-forming portion and the annular flat surface formed between the upper peripheral edge of the annular side surface and the peripheral edge of the lower surface of the flange body portion; and

the ring-shaped resinous member does not cover the seat surface of the seat surface-forming portion, but covers the annular side surface of the seat surface-forming portion, the annular flat surface of the flange body portion, the annular side surface of the flange body portion, and the annular peripheral edge of the upper surface of the flange body portion.

(4) In the nut according to any one of the above-described (1) through (3), the ring-shaped resinous member becomes gradually thinner to the edge part.

(5) In the nut according to any one of the above-described (1) through (3), the annular skirt part has the flat portion formed in the neighborhood of the edge part.

(6) In the nut according to any one of the above-described (1) through (4), the annular skirt part has the inner annular portion having the curved surface bulged outward and the outer annular portion inwardly curved a little.

(7) In the nut according to any one of the above-described (1) through (6), the unconductive ring-shaped resinous member is formed on the nut body by insert molding.

(8) In the nut according to any one of the above-described (1) through (7), the annular skirt part elastically deforms when the nut is mounted on the portion where the nut is to be mounted; and following the deformation of the annular skirt part, the ring-shaped resinous member is pressed against the annular peripheral edge of the upper surface of the flange body portion.

(9) In the nut according to any one of the above-described (1) through (8), the annular skirt part becomes taperingly larger to the edge part in the diameter thereof; and the taper angle of the annular skirt part with respect to the axis of the screw part is 60° to 89°.

(10) In the nut according to any one of the above-described (1) through (9), the projected length L of the distal end of the edge part with respect to the seat surface is 0.05 mm to 1.5 mm.

(11) In the nut according to any one of the above-described (1) through (10), the unconductive ring-shaped resinous member is made of the unconductive resin having the tensile break elongation not less than 15%.

(12) In the nut according to any one of the above-described (1) through (11), the upper portion of the female screw part is dosed to form a bag-shaped nut.

(13) The nut according to any one of the above-described (1) through (11) has the shaft part extended downward from the flange part; and the shaft part is provided with the female screw part.

1. A nut comprising a nut body including a female screw part extended axially and a flange part projected outward from a side surface of said nut body and an unconductive ring-shaped resinous member covering a peripheral portion of said flange part,
said flange part has a disk-shaped flange body portion; and a seat surface-forming portion which is extended downward from a lower surface of said flange body portion and has a smaller diameter than said flange body portion and a seat surface to be pressed against a portion where said nut is to be mounted;
said ring-shaped resinous member has an edge part located below said seat surface and outward from said flange body portion and an annular skirt part whose diameter gradually increases to said edge part; and
said annular skirt part deforms in mounting said nut on said portion where said nut is to be mounted in such a way that said annular skirt part does not prevent said seat surface from being pressed against said portion where said nut is to be mounted and forms an annular liquid-tight sealing portion for said portion where said nut is to be mounted.

2. A nut according to claim 1, wherein said annular skirt part increases to said edge part in a diameter thereof taperingly or curvedly.

3. A nut according to claim 1, wherein said nut body has an annular side surface formed by a side surface of said seat surface-forming portion and an annular flat surface formed between an upper peripheral edge of said annular side surface and a peripheral edge of said lower surface of said flange body portion; and
said ring-shaped resinous member does not cover said seat surface of said seat surface-forming portion, but covers said annular side surface of said seat surface-forming portion, said annular flat surface of said flange body portion, an annular side surface of said flange body portion, and an annular peripheral edge of an upper surface of said flange body portion.

4. A nut according to any one of claims 1 through 3 claim 1, wherein said ring-shaped resinous member becomes gradually thinner to said edge part.

5. A nut according to any one of claims 1 through 3 claim 1, wherein said annular skirt part has a flat portion formed in a neighborhood of said edge part.

6. A nut according to claim 1, wherein said annular skirt part has an inner annular portion having a curved surface bulged outward and an outer annular portion inwardly curved a little.

7. A nut according to claim 1, wherein said unconductive ring-shaped resinous member is formed on said nut body by insert molding.

8. A nut according to claim 1, wherein said annular skirt part elastically deforms when said nut is mounted on said portion where said nut is to be mounted; and following deformation of said annular skirt part, said ring-shaped resinous member is pressed against said annular peripheral edge of said upper-surface of said flange body portion.

9. A nut according to claim 1, wherein said annular skirt part becomes taperingly larger to said edge part in a diameter thereof; and a taper angle of said annular skirt part with respect to an axis of said screw part is 60° to 89°.

10. A nut according to claim 1, wherein a projected length of a distal end of said edge part with respect to said seat surface is 0.05 mm to 1.5 mm.

11. A nut according to claim 1, wherein said unconductive ring-shaped resinous member is made of an unconductive resin having a tensile break elongation not less than 15%.

12. A nut according to claim 1, which is a bag-shaped nut in which an upper portion of said female screw part is closed.

13. A nut according to claim 1, having a shaft part extended downward from said flange part; and said shaft part is provided with said female screw part.
